(19) United States
(12) Patent Application Publication
(10) Pub. No.: US 2010/0017122 A1
(43) Pub. Date: Jan. 21, 2010

(54) Route Plan Configuring Device Configured to a Navigation Device and Related Method and Navigation Device

(76) Inventor: Yao-Tsung Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/254,844

(22) Filed: Oct. 21, 2008

(30) Foreign Application Priority Data
Jul. 18, 2008 (TW) 097127314

(51) Int. Cl. G01C 21/36

(52) U.S. Cl. 701/210

(57) ABSTRACT

A route plan configuring device for a navigation device includes a sensor installed on a vehicle for carrying an identification data corresponding to the vehicle, a sensing circuit installed in the navigation device for sensing the sensor to generating a sensing result, and a control module installed in the navigation device and coupled to the sensing circuit for adjusting route plans of the navigation device according to the sensing result.

### BACKGROUND OF THE INVENTION

1. Field of the Invention

The present invention relates to a route plan configuring device configured to a navigation device, related method and navigation device, and more particularly, to a route plan configuring device configured to a navigation device, related method and navigation device capable of automatically configuring the navigation mode according to different types of vehicles and enhancing using convenience.

2. Description of the Prior Art

With progress of technology, a Personal Navigation Device (PND) is more and more popular in the market, and is adapted by customers widely. Generally speaking, the Personal Navigation Device is configured a route plan or navigates according to user's requirements on the basis of existing geographic information. Besides, different route plans corresponding to different vehicle types are provided by the Personal Navigation Device. Take the same destination for example. If the user drives a car, the Personal Navigation Device should be configured high-speed roads or elevated roads in the corresponding route plan, to save traffic time. If the user rides a motor scooter, the Personal Navigation Device should be avoided being configured high-speed roads or elevated roads in the corresponding route plan, so as to conform to traffic laws. If the user goes on foot, pavements should be configured by the user in priority for safety.

Route plans provided based on vehicle types can enhance driving efficiencies, prevent the user from violating traffic laws, and keep the user in safe. However, in the prior art, the Personal Navigation Device is incapable of automatically adjusting a route plan according to different vehicles. Instead, the user needs to configure the route plans manually, resulting in tedious inconvenience. For example, if the user wants to drive to a travel spot for a hike, when the user drives the car, the user needs to manually configure the Personal Navigation Device to operate in a car-navigation mode, and after reaching the travel spot, the user again needs to manually configure the Personal Navigation Device to operate in an on-foot-navigation mode. Obviously, repeated configuration manually is time-wasted and mentality-tortured, thus causing tedious inconvenience for the user.

### SUMMARY OF THE INVENTION

It is therefore a primary objective of the claimed invention to provide a route plan configuring device configured to a navigation device and related method and navigation device.

The present invention discloses a route plan configuring device configured to a navigation device. The route plan configuring device comprises a sensor, a sensing circuit and a control module. The sensor is installed on a vehicle for carrying an identification data corresponding to the vehicle. The sensing circuit is installed in the navigation device for sensing the sensor to generate a sensing result. The control module is installed in the navigation device, and is coupled to the sensing circuit for adjusting a route plan of the navigation device according to the sensing result.

The present invention further discloses a method for configuring a route plan for a navigation device. The navigation device comprises a sensor installed on a vehicle. The sensor carries an identification data corresponding to the vehicle. The method comprises sensing the sensor to generate a sensing result, and adjusting the route plan of the navigation device according to the sensing result.

The present invention further discloses a navigation device capable of automatically configuring a route plan. The navigation device comprises a display device, a positioning device, a geographic information database, a navigation processor and a route plan configuring device.

The positioning device is utilized for generating a positioning information. The geographic information database is utilized for storing a geographic data. The navigation processor is coupled to the display device, the positioning device and the geographic information database, and is utilized for displaying navigation results on the display device according to the positioning information. The route plan configuring device comprises a plurality of sensors, a sensing circuit and a control module. The plurality of sensors is installed on a plurality of vehicles for carrying identification data corresponding to the plurality of vehicles. The sensing circuit is utilized for sensing the plurality of sensors to generate a sensing result. The control module is coupled to the sensing circuit and the navigation processor, and is utilized for adjusting the route plan of the navigation processor according to the sensing result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a route plan configuring device according to an embodiment of the present invention.

FIG. 2 is a schematic diagram of a route plan configuring procedure according to an embodiment of the present invention.

FIG. 3 is a schematic diagram of a navigation device according to an embodiment of the present invention.

FIG. 4 is a schematic diagram of a route plan configuring procedure according to an embodiment of the present invention.

### DETAILED DESCRIPTION

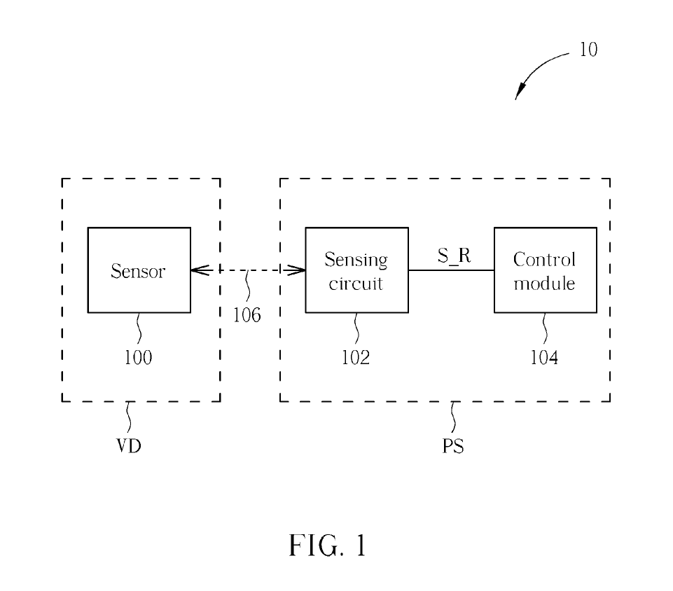

Please refer to FIG. 1. FIG. 1 is a schematic diagram of a route plan configuring device 10 according to an embodiment of the present invention. The route plan configuring device 10 is configured to a navigation device PS, for automatically adjusting a route plan of the navigation device PS according to a vehicle VD driven or taken by a user. The route plan configuring device 10 comprises a sensor 100, a sensing circuit 102 and a control module 104. The sensor 100 is installed on the vehicle VD, and carries identification data corresponding to the vehicle VD. The sensing circuit 102 is installed in the navigation device PS, and utilized for sensing the sensor 100 to generate a sensing result S_R. The control module 104 is coupled to the sensing circuit 102, and utilized for adjusting the route plan of the navigation device PS according to the sensing result S_R.

In short, the present invention senses the sensor 100 and obtains the identification data carried by the sensor 100, to timely adjust the route plan of the navigation device PS. For example, if the vehicle VD is a car, the control module 104 can adjust the route plan of the navigation device PS in conformation with a car-navigation mode after the sensing circuit 102 senses the sensor 100. In other words, after the sensing circuit 102 senses the sensor 100, the control module 104 determines a type of the vehicle VD to automatically adjust the route plan of the navigation device PS. In such a case, the user does not need to manually configure the route plan of the navigation device PS, thereby enhancing using convenience.

Please note that, FIG. 1 is an exemplary embodiment of the present invention, and those skilled in the art can make alternations and modifications accordingly. For example, the sensor 100 is preferably installed in a carrier of the vehicle VD, which is utilized for carrying the navigation device PS. As a result, the sensing circuit 102 can sense the sensor 100 once the navigation device PS is fixed to the carrier of the vehicle VD. Moreover, in FIG. 1, the sensing circuit 102 senses the sensor 100 via a route 106, which is utilized for indicating a signal connection between the sensing circuit 102 and the sensor 100. In fact, the route 106 is not limited to any type of wire or wireless connection. If the route 106 is a wire connection, the sensing circuit 102 senses the sensor 100 via a physical wire, e.g. a pin or contact. In such a case, the sensor 100 can be an analog circuit for generating electrical characteristics, e.g. voltage, current, impedance, to carry the identification data of the vehicle VD. On the other hand, if the route 106 is a wireless connection, the sensing circuit 102 senses the sensor 100 via wireless communication, e.g. Radio-frequency identification (RFID), infrared sensing, barcode identification, etc. In such a case, the sensor 100 is digital data stored in the vehicle VD.

Note that, when designing the sensor 100 and the sensing circuit 102, those skilled in the art needs to consider whether the sensor 100 and the sensing circuit 102 match with each other, to keep the route plan configuring device 10 in normal operation. For example, if the sensor 100 is a barcode, the sensing circuit 102 is a barcode reader. If the sensor 100 is an RFID tag, the sensing circuit 102 is an RFID reader.

Besides, the control module 104 can further store and set a look-up table. In other words, when the sensing circuit 102 has sensed the sensor 100, the control module 104 can rapidly determine the type of the vehicle VD by referring to the look-up table. However, when the control module 104 is incapable of determining the type of the vehicle VD via the look-up table, the control module 104 can set contents of the look-up table.

Moreover, when the sensing result S_R indicates that the sensing circuit 102 is incapable of sensing the sensor 100, the control module 104 can adjust the route plan of the navigation device PS to be a default route plan, such as an on-foot route plan. In other words, if the vehicle VD is a car, when the navigation device PS is fixed to the carrier of the vehicle VD, the control module 104 can adjust the route plan of the navigation device PS to conform to the car-navigation mode. If the navigation device PS is taken apart from the carrier of the vehicle VD, the control module 104 will adjust the route plan of the navigation device PS to be the on-foot route plan. As a result, the user does not need to configure the route plan of the navigation device PS manually, thereby enhancing convenience.

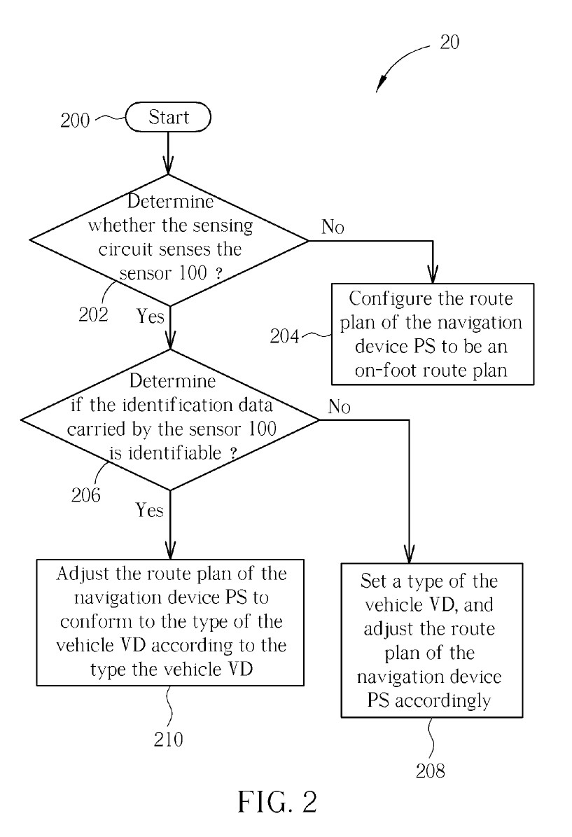

Please refer to FIG. 2. FIG. 2 is a schematic diagram of a route plan configuring procedure 20 according to an embodiment of the present invention. The route plan configuring procedure 20 is utilized in the route plan configuring device 10, and comprises the following steps:

Step 200: Start.

Step 202: Determine whether the sensing circuit 102 senses the sensor 100. If so, go to Step 206; if not, go to Step 204.

Step 204: Configure the route plan of the navigation device PS to be an on-foot route plan.

Step 206: Determine if the identification data carried by the sensor 100 is identifiable. If so, go to Step 210; if not, go to Step 208.

Step 208: Set a type of the vehicle VD, and adjust the route plan of the navigation device PS accordingly.

Step 210: Adjust the route plan of the navigation device PS to conform to the type of the vehicle VD according to the type the vehicle VD.

The route plan configuring procedure 20 is utilized in the route plan configuring device 10 for automatically adjusting the route plan, and the detail operations can be referred hereinbefore, so is omitted.

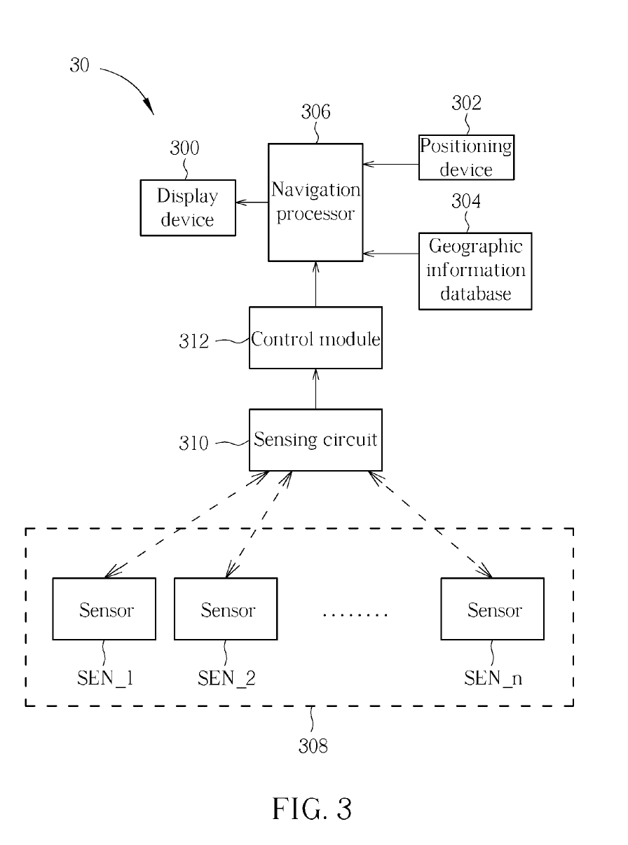

As mentioned above, FIG. 1 depicts the exemplary embodiment of the present invention, and those skilled in the art can make alternations and modifications accordingly. For example, please refer to FIG. 3. FIG. 3 is a schematic diagram of a navigation device 30 according to an embodiment of the present invention. The navigation device 30 can automatically configure a route plan, and comprises a display device 300, a positioning device 302, a geographic information database 304, a navigation processor 306 and a route plan configuring device 308. The positioning device 302 can be a positioning device using Global Positioning System or other positioning system, and is utilized for generating positioning information. The geographic information database 304 is utilized for storing a geographic data. The navigation processor 306 can display navigation results on the display device 300 according to the positioning information generated by the positioning device 302. Moreover, the route plan configuring device 308 is utilized for automatically configuring the route plan of the navigation processor 306, and comprises sensors SEN_1˜SEN_n, a sensing circuit 310 and a control module 312. The sensors SEN_1˜SEN_n are installed on “n” vehicles, and carry identification data corresponding to each vehicle respectively. The sensing circuit 310 is utilized for sensing the sensors SEN_1˜SEN_n to generate a sensing result S_Rn. The control module 312 is coupled to the sensing circuit 310 and the navigation processor 306, and is utilized for adjusting the route plan of the navigation processor 306 according to the sensing result S_Rn.

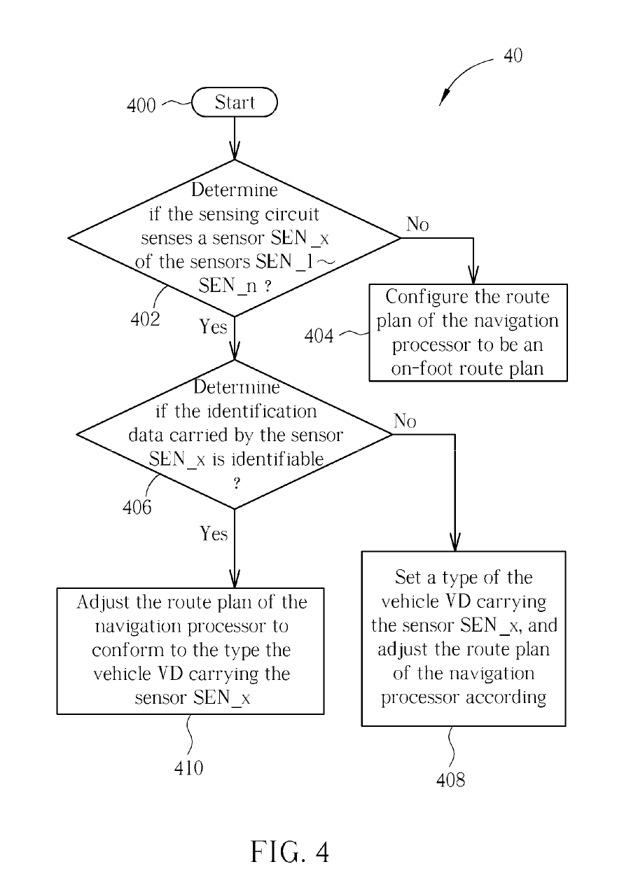

Comparing FIG. 3 and FIG. 1, the structure and operation of the route plan configuring device 308 is similar to those of the route plan configuring device 10, while the difference is that the route plan configuring device 308 comprises n sensors, and the route plan configuring device 10 comprises only one sensor. In short, the route plan configuring device 308 is derived from the route plan configuring device 10. Therefore, the related varied embodiments, e.g. designs of the sensors SEN_1˜SEN_n, can be referred to the descriptions hereinbefore. In the same way, the route plan configuring procedure 20 can be modified to fit the route plan configuring device 308. Please refer to FIG. 4. FIG. 4 is a schematic diagram of a route plan configuring procedure 40 according to an embodiment of the present invention. The route plan configuring procedure 40 is utilized in the route plan configuring device 308, and comprises the following steps:

Step 400: Start.

Step 402: Determine if the sensing circuit 310 senses a sensor SEN_x of the sensors SEN_1˜SEN_n. If so, go to Step 406; if not, go to Step 404.

Step 404: Configure the route plan of the navigation processor 306 to be an on-foot route plan.

Step 406: Determine if the identification data carried by the sensor SEN_x is identifiable. If so, go to Step 410; if not, go to Step 408.

Step 408: Set a type of the vehicle VD carrying the sensor SEN_x, and adjust the route plan of the navigation processor 306 accordingly.

Step 410: Adjust the route plan of the navigation processor 306 to conform to the type the vehicle VD carrying the sensor SEN_x.

Therefore, according to the procedure 40, after the sensing circuit 310 senses a sensor SEN_x, the control module 312 will determine if the identification data carried by the sensor SEN_x is identifiable. If the identification data carried by the sensor SEN_x is identifiable, the control module 312 can adjust the route plan of the navigation processor 306 to conform to the type the vehicle VD carrying the sensor SEN_x by refereeing to a look-up table or other reference. On the contrary, if the identification data carried by the sensor SEN_x is not identifiable, the control module 312 can set or update the look-up table, and adjust the corresponding route plan according to the updated data. In addition, if the sensing circuit 310 is incapable of sensing any of the sensors SEN_1˜SEN_n, the control module 312 will adjust the route plan of the navigation processor 306 to be an on-foot route plan. As a result, the user does not need to configure the route plan of the navigation processor 306 manually, thereby enhancing convenience.

For example, suppose the number of the sensors SEN_1˜SEN_n is 2, namely n=2, and the sensor SEN_1 is installed in a carrier of a car while the sensor SEN_2 is installed in a carrier of a foldable bike. If the user wants to drive to a travel spot for biking, the user only needs to fix the navigation device 30 to the carrier of the car to activate the car-navigation mode. After reaching the travel spot, the user can fix the navigation device 30 to the carrier of the foldable bike to activate the bike-navigation mode. Furthermore, if the user takes apart the navigation device 30 from the carrier of the foldable bike, the on-foot-navigation mode is activated. Obviously, the user does not need to configure the navigation mode manually, thereby enhancing convenience dramatically. Besides, since the navigation device 30 can automatically configure the navigation mode according to different types of vehicles, the present invention can enhance driving efficiency, avoid violating traffic laws and keep safety.

In conclusion, the present invention can automatically configure the navigation mode according to different types of vehicles, thereby enhancing using convenience.

Those skilled in the art will readily observe that numerous modifications and alterations of the device and method may be made while retaining the teachings of the invention.

What is claimed is:

1. A route plan configuring device configured to a navigation device comprising:
a sensor installed on a vehicle for carrying an identification data corresponding to the vehicle;
a sensing circuit installed in the navigation device for sensing the sensor to generate a sensing result; and
a control module installed in the navigation device and coupled to the sensing circuit for adjusting a route plan of the navigation device according to the sensing result.

2. The route plan configuring device of claim 1, wherein the sensor is installed in a carrier of the vehicle, and the carrier is utilized for carrying the navigation device.

3. The route plan configuring device of claim 1, wherein the sensor carries the identification data corresponding to the vehicle with an analog circuit.

4. The route plan configuring device of claim 3, wherein the sensing circuit senses the sensor to generate the sensing result via a wire.

5. The route plan configuring device of claim 1, wherein the sensor stores a digital data to carry the identification data corresponding to the vehicle.

6. The route plan configuring device of claim 5, wherein the sensing circuit senses the sensor to generate the sensing result via wireless communication.

7. The route plan configuring device of claim 1, wherein when the sensing result indicates that the sensing circuit has sensed the sensor, the control module can determine a type of the vehicle according to the identification data which is carried by the sensor and corresponding to the vehicle, so as to adjust the route plan of the navigation device to conform to the type of the vehicle.

8. The route plan configuring device of claim 7, wherein the control module is further utilized for storing a look-up table, and refers to the look-up table according to the identification data which is carried by the sensor and corresponding to the vehicle, so as to determine the type of the vehicle.

9. The route plan configuring device of claim 8, wherein the control module is further utilized for setting contents of the look-up table when the control module is incapable of determining the type of the vehicle via the look-up table.

10. The route plan configuring device of claim 1, wherein the control module adjusts the route plan of the navigation device to be a default route plan when the sensing result indicates that the sensing circuit is incapable of sensing the sensor.

11. The route plan configuring device of claim 10, wherein the default route plan is an on-foot route plan.

12. A method for configuring a route plan for a navigation device, the navigation device comprising a sensor installed on a vehicle, the sensor carrying an identification data corresponding to the vehicle, the method comprising:
sensing the sensor to generate a sensing result; and
adjusting the route plan of the navigation device according to the sensing result.

13. The method of claim 12, wherein adjusting the route plan of the navigation device according to the sensing result is when the sensing result indicates that the sensor has been sensed, determining a type of the vehicle according to the identification data which is carried by the sensor and corresponding to the vehicle, so as to adjust the route plan of the navigation device to conform to the type of the vehicle.

14. The method of claim 13 further comprising storing a look-up table, for referring to the look-up table according to the identification data corresponding to the vehicle carried by the sensor, so as to determine the type of the vehicle.

15. The method of claim 14 further comprising setting contents of the look-up table when the type of the vehicle is incapable of being determined via the look-up table.

16. The method of claim 12, wherein adjusting the route plan of the navigation device according to the sensing result is adjusting the route plan of the navigation device to be a default route plan when the sensing result indicates that the sensor is not sensed.

17. The method of claim 16, wherein the default route plan is an on-foot route plan.

18. A navigation device capable of automatically configuring a route plan comprising:
a display device;
a positioning device for generating a positioning information;
a geographic information database for storing a geographic data;
a navigation processor coupled to the display device, the positioning device and the geographic information database, for displaying navigation results on the display device according to the positioning information; and
a route plan configuring device comprising:
a plurality of sensors installed on a plurality of vehicles for carrying identification data corresponding to the plurality of vehicles;
a sensing circuit for sensing the plurality of sensors to generate a sensing result; and
a control module coupled to the sensing circuit and the navigation processor, for adjusting the route plan of the navigation processor according to the sensing result.

19. The navigation device of claim 18, wherein the plurality of sensors are installed in a plurality of carriers of the plurality of vehicles, and the plurality of carriers are utilized for carrying the navigation device.

20. The navigation device of claim 18, wherein the plurality of sensors carry the identification data corresponding to the plurality of vehicles with a plurality of analog circuits.

21. The navigation device of claim 20, wherein the sensing circuit senses the plurality of sensors to generate the sensing result via a wire.

22. The navigation device of claim 18, wherein the plurality of sensors store a plurality of digital data to carry the identification data corresponding to the plurality of vehicles.

23. The navigation device of claim 22, wherein the sensing circuit senses the plurality of sensors to generate the sensing result via wireless communication.

24. The navigation device of claim 18, wherein when the sensing result indicates that the sensing circuit has sensed the first sensor, the control module can determine a type of a first vehicle according to an identification data which is carried by a first sensor of the plurality of sensors and corresponding to the first vehicle, so as to adjust the route plan of the navigation device to conform to the type of the first vehicle.

25. The navigation device of claim 24, wherein the control module is further utilized for storing a look-up table, and refers to the look-up table according to the identification data corresponding to the first vehicle carried by the first sensor, so as to determine the type of the first vehicle.

26. The navigation device of claim 25, wherein the control module is further utilized for setting contents of the look-up table when the control module is incapable of determining the type of the first vehicle via the look-up table.

27. The navigation device of claim 18, wherein the control module adjusts the route plan of the navigation device to be a default route plan when the sensing result indicates that the sensing circuit is incapable of sensing any of the plurality of sensors.

28. The navigation device of claim 27, wherein the default route plan is an on-foot route plan.
